(19) United States
(12) Patent Application Publication
(10) Pub. No.: US 2022/0122009 A1
(43) Pub. Date: Apr. 21, 2022

(54) METHODS AND APPARATUS FOR DETERMINING AND PREVENTING RISK OF HUMAN INJURY

(71) Applicant: StrongArm Technologies, Inc., Brooklyn, NY (US)

(72) Inventors: Sean Michael Petterson, Patchogue, NY (US); Michael Dohyun Kim, Sunnyside, NY (US); Michael Patrick Spinelli, Croton, NY (US)

(21) Appl. No.: 17/505,562

(22) Filed: Oct. 19, 2021

Related U.S. Application Data
(60) Provisional application No. 63/093,374, filed on Oct. 19, 2020.

(51) Int. Cl. G06Q 10/06; G08B 21/02; G06K 9/62; H04L 67/12

(52) U.S. Cl. CPC G06Q 10/0635; H04L 67/12; G06K 9/6293; G08B 21/02

(57) ABSTRACT

Systems and methods of the present disclosure enable determining and preventing risk of human injury. Raw sensor data is received via sensors including one motion-related measurements of motion of the user. An aggregate motion value associated with a motion is determined based on a subset of the raw sensor data. A risk metric is determined based on the aggregate motion value. A dynamic risk metric is determined based on a risk metric history and the risk metric, where the dynamic risk metric is indicative of an injury risk associated with the user. A dynamic annoyance metric is determined based on a previous alert associated with the user, where the dynamic annoyance metric is indicative of an alert cadence and is customized based on user behavior. An alert is generated upon a determination that the dynamic risk metric has reached a predetermined threshold based on the dynamic annoyance metric.

### CLAIM TO PRIORITY

This application claims priority to U.S. Provisional Application No. 63/093,374 filed on 19 Oct. 2020 and entitled “METHODS AND APPARATUS FOR DETERMINING AND PREVENTING RISK OF HUMAN INJURY,” and is herein incorporated by reference in its entirety.

### BACKGROUND OF TECHNOLOGY

Physical injuries incubate over time, knowledge regarding risks of injury can facilitate early intervention and prevention of physical injuries.

### SUMMARY OF DESCRIBED SUBJECT MATTER

Some embodiments are directed to an apparatus. The apparatus includes a processor; a set of sensors; and a non-transitory memory storing instructions which, when executed by the processor, causes the processor to capture raw sensor data via the set of sensors while a user performs a series of activities wearing the set of sensors for a predetermined time. The apparatus determines a dynamic risk metric based on the raw sensor data, wherein the dynamic risk metric is indicative of an injury risk associated with the user. The apparatus generates, based on a dynamic annoyance metric indicative of an alert cadence, an alert upon a determination that the dynamic risk metric has reached a predetermined threshold, wherein the dynamic annoyance metric is customized based on at least one user behavior.

Embodiments of the present disclosure include one or more systems for determining and preventing risk of human injury. The system(s) include a processor, a set of sensors associated with a user, where the set of sensors produce raw sensor data including at least one motion-related measurement of motion of the user; and a non-transitory memory storing instructions. The software instructions, when executed by the processor, causes the processor to: receive the raw sensor data via the set of sensors; determine at least one aggregate motion value associated with at least one motion based at least in part on at least one statistical aggregation of at least one subset of the raw sensor data; determine a risk metric based at least in part on the at least one aggregate motion value to represent a risk of injury associated with the at least one subset of the raw sensor data; access a risk history including a plurality of historical risk scores associated with the user; determine a dynamic risk metric based at least in part on the risk history and the risk metric, where the dynamic risk metric is indicative of an injury risk associated with the user; determine a dynamic annoyance metric based at least in part on at least one previous alert associated with the user; where the dynamic annoyance metric is indicative of an alert cadence; where the dynamic annoyance metric is customized based on at least one user behavior; and generate, based on the dynamic annoyance metric, an alert upon a determination that the dynamic risk metric has reached a predetermined threshold.

Embodiments of the present disclosure include one or more methods for determining and preventing risk of human injury. The method(s) include receiving, by at least one processor, raw sensor data via a set of sensors; where the raw sensor data includes at least one motion-related measurement of motion of the user; determining, by the at least one processor, at least one aggregate motion value associated with at least one motion based at least in part on at least one statistical aggregation of at least one subset of the raw sensor data; determining, by the at least one processor, a risk metric based at least in part on the at least one aggregate motion value to represent a risk of injury associated with the at least one subset of the raw sensor data; accessing, by the at least one processor, a risk history including a plurality of historical risk scores associated with the user; determining, by the at least one processor, a dynamic risk metric based at least in part on the risk history and the risk metric, where the dynamic risk metric is indicative of an injury risk associated with the user; determining, by the at least one processor, a dynamic annoyance metric based at least in part on at least one previous alert associated with the user; where the dynamic annoyance metric is indicative of an alert cadence; where the dynamic annoyance metric is customized based on at least one user behavior; and generating, by the at least one processor, based on the dynamic annoyance metric, an alert upon a determination that the dynamic risk metric has reached a predetermined threshold.

The system(s) and method(s) of the present disclosure include embodiments where the non-transitory memory storing instructions which, when executed by the processor, further causes the processor to: utilize at least one task recognition model to identify at least one task associated with the motion of the user based at least in part on the raw sensor data; determine at least one window of time spanning a period of time defined by the at least one task; generate at least one window data structure including the subset of the raw sensor; where the subset of raw sensor data is associated with the at least one window of time; and determine at least one aggregate motion value associated with at least one motion represented within the at least one window data structure based at least in part on at least one statistical aggregation of the subset of the raw sensor data.

The system(s) and method(s) of the present disclosure include embodiments where the non-transitory memory storing instructions which, when executed by the processor, further causes the processor to: determine a decayed sum associated with the risk metric based at least in part on the risk history.

The system(s) and method(s) of the present disclosure include embodiments where the risk metric includes at least one of: an action count representing a number of actions performed, a Safety Score, a National Institute for Occupational Safety and Health (NIOSH) Lifting Equation, a Washington Industrial Safety and Health Act (WISHA) lifting equation, a WISHH Lifting Equation, selected factors specific to task, or personalized factors associated with an educational program.

The system(s) and method(s) of the present disclosure include embodiments where the non-transitory memory storing instructions which, when executed by the processor, further causes the processor to: access an alert log storing at least one record of the at least one previous alert; where the at least one record includes: at least one user feedback in response to the at least one previous alert and at least one alert time associated with the at least one previous alert; determine a perceived annoyance associated with the alert based at least in part on the at least one previous alert and the at least one user feedback; and determine the dynamic annoyance metric based at least in part on the perceived annoyance.

The system(s) and method(s) of the present disclosure include embodiments where the non-transitory memory storing instructions which, when executed by the processor, further causes the processor to: determine a decayed sum associated with the perceived annoyance based at least in part on the at least one record of the at least one previous alert; and generating the dynamic annoyance metric based at least in part on the decayed sum associated with the perceived annoyance.

The system(s) and method(s) of the present disclosure include embodiments where the non-transitory memory storing instructions which, when executed by the processor, further causes the processor to: receive at least one user feedback in response to the alert; and store a record of the alert and the at least one user feedback in the alert log.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art one or more illustrative embodiments.

FIGS. 1A-13 show one or more schematic flow diagrams, certain computer-based architectures, and/or implementations which are illustrative of some examples of aspects of at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given about the various embodiments of the present disclosure is intended to be illustrative, and not restrictive.

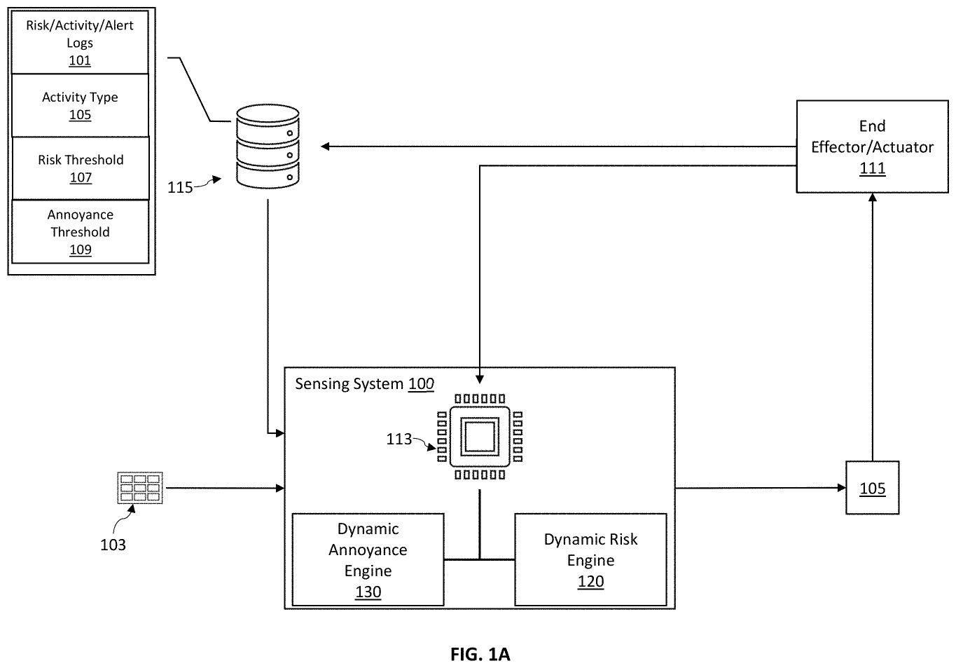

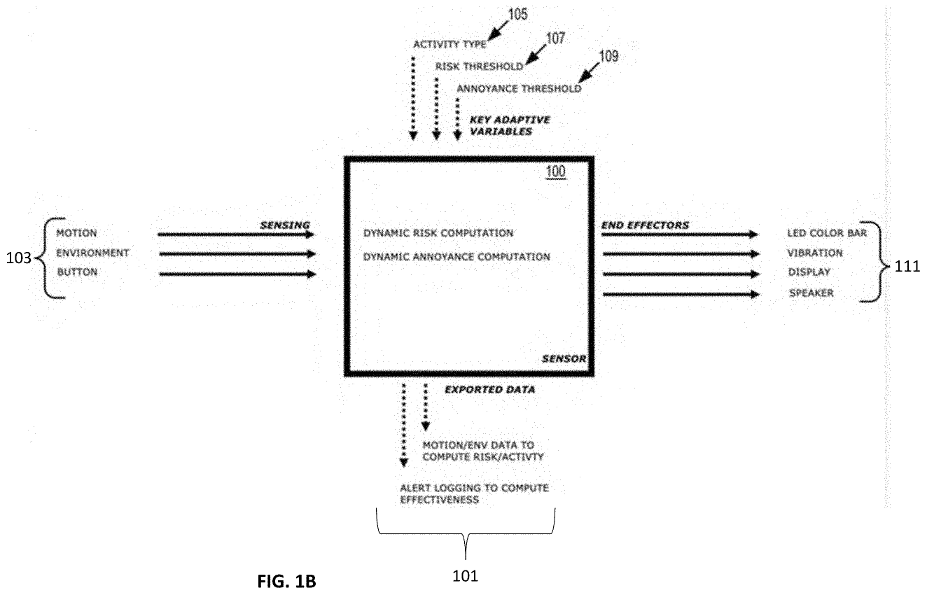

FIGS. 1A through 13 illustrate computer based systems and methods for preventing and determining risks of human injuries.

A technical problem with postural guidance devices that trigger vibrations or alerts when a user poses at certain angles, is that such vibrations or alerts do not respond to risk of activities that a user is performing and do not adapt to a user reaction to an alert.

As explained in more detail below, the technical solutions described herein include the implementation of prior statistically-tested risk calculation systems and methods to trigger behavior-correcting alerts in real-time in response to live motion. Such systems and methods determine the timing of alerts and their paradigm of risk calculation can be modulated in real-time and adapted over several sessions to create an evolving, alerting cadence personalized to the user and responsive to the specific risk of repetitive tasks.

FIG. 1A and FIG. 1B illustrate an example of an implementation of a sensing system, in accordance with one or more embodiments of the present disclosure. In some embodiments, the system 100 can include multiple sensors 103 and effectors or actuators 111. In some implementations, sensors 103 can include, for example, an accelerometer, a gyroscope, a yaw sensor, a pitch sensor, a roll sensor, a magnetometer sensor, thermometer, push buttons, or other suitable sensors. In some implementations, effectors or actuators 111 can include touch screens, displays, light emitting diodes (LED), vibrating motors, speakers, or other suitable effectors or actuators 111 that may be used to indicate an output and/or alert to a user based on the dynamic risk computation and dynamic annoyance computation according to data from the sensors 103. In some embodiments, the end effectors or actuators 111 may provide feedback to the sensing system 100 and/or data for logging by the data storage solution 115 based on, e.g., user interaction with the end effectors or actuators 111.

In some embodiments, the sensing system 100 may be in communication with one or more data storage solutions 115. In some embodiments, the data storage solution 115 may include, e.g., a suitable memory or storage solutions for maintaining electronic data representing the activity histories for each account. For example, the data storage solution 115 may include database technology such as, e.g., a centralized or distributed database, cloud storage platform, decentralized system, server or server system, among other storage systems. In some embodiments, the data storage solution may, additionally or alternatively, include one or more data storage devices such as, e.g., a hard drive, solid-state drive, flash drive, or other suitable storage device. In some embodiments, the data storage solution 115 may, additionally or alternatively, include one or more temporary storage devices such as, e.g., a random-access memory, cache, buffer, or other suitable memory device, or any other data storage solution and combinations thereof. In some embodiments, the data storage solution 115 may include any suitable combination of the above for storing and providing data from the sensing system 100.

In some embodiments, the sensing system 100 can process inputs or key adaptive variables retrieved or otherwise received from the data storage solution 115, e.g., including activity type 105, risk threshold 107, annoyance threshold 109, or other suitable inputs to generate alerts via, for example, effectors or actuators 111. Such alerts can be based on a risk of injury related to an activity performed by a user, postural hygiene being held by the user, or other suitable motions or poses performed or held by a user.

In some embodiments, sensing system 100 can be a self-adapted system and a personalized alerting system that targets key concerns of user's safety in real-time while adapting to how a user interacts with the system over several instances of usage to ensure an optimal pairing between the user and the sensing system 100. In some implementations, sensing system 100 can provide recommendations to a user based on detected motions or poses. Such recommendations can be controlled to ensure an optimal feedback cadence.

In some embodiments, the sensing system 100 may include computer engines for processing the data from the sensors 103, including e.g., a dynamic risk engine 120 and a dynamic annoyance engine 130. In some embodiments, a “computer engine” or “engine” may identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, the sensing system 100 may monitor user risk in real-time or near real-time and utilize the dynamic risk engine 120 to instantaneously compute measures of accumulated risk in a Dynamic Risk Metric (DRM) based on the data from the sensors 103 and the key adaptive variables, such as activity type 105 and risk threshold 107. In some embodiments, the sensing system 100 may monitor user risk via a stream of constant, intermittent, periodic or on any other suitable frequency or any combination thereof, of the sensors 103. In some embodiments, the sensing system 100 may monitor user risk via batches of data from the sensors 103, where the batches are scheduled on an intermittent, periodic or on any other suitable frequency or any combination thereof. In some embodiments, the DRM may be represent increasing risk levels based on repeated unsafe actions or poses and/or decreasing risk levels when periods of rest or limited movement are detected.

In some implementations, the sensing system 100 can monitor (e.g., as a stream and/or in batches) the number of alerts delivered to a user through the effectors or actuators 111 utilize the dynamic annoyance engine 130 to compute a Dynamic Annoyance Metric (DAM) which represents the real-time density of alerts. The DAM may be based on a history of alerts, including one or more previous alerts provided to the user, user responses to the history of alerts (e.g., user selections associated with effector and/or actuator 111, changes to user motions, among other user responses and any combination thereof). The computed DAM can be utilized by the sensing system 100 to prevent over-stimulation, annoyance, or disengagement of the user that can occur if the sensing system 100 emits multiple unwelcome alerts.

In some implementations, the DRM can be adapted to the type of activity a user is performing, for example, if the activity type 105 corresponds to picking objects the DRM can be based on the speed and depth associated with a picked objected. For another example, if the activity type 105 corresponds to a manufacturing operation with prolonged time in a specific posture, the DRM can be incremented based on time spent in high-risk postures.

In some embodiments, in some embodiments, the risk threshold 107 may be any suitable static or dynamic threshold or any combination thereof. A static threshold may include a predefined threshold value or values, e.g., via user selection, automatically selected (e.g., for a particular user, activity or other attribute or any combination thereof), or a hardcoded value(s), or any combination thereof. In some embodiments, a dynamic threshold may include any suitable adaptable threshold that varies through time based on, e.g., current input, historical input, user feedback, current output, historical output, or other suitable parameters for adjusting risk. For example, the risk threshold 107 can be adapted based on a baseline overall average of DRM providing basis for daily continual improvement.

Similarly, in some embodiments, the annoyance threshold 109 may be any suitable static or dynamic threshold or any combination thereof. For example, the annoyance threshold 109 can be adapted based on a computation of the effectiveness of each alert emitted by the sensing system 100, for example, by increasing the annoyance threshold 109 until the effectiveness of the alert decreases or decreasing the annoyance threshold 109 until the effectiveness of the alert increases.

In some implementations, the sensing system 100 can export or transmit data to a computing device such as motion data, environment data, and/or alert logs to compute effectiveness or other suitable data as shown at 101.

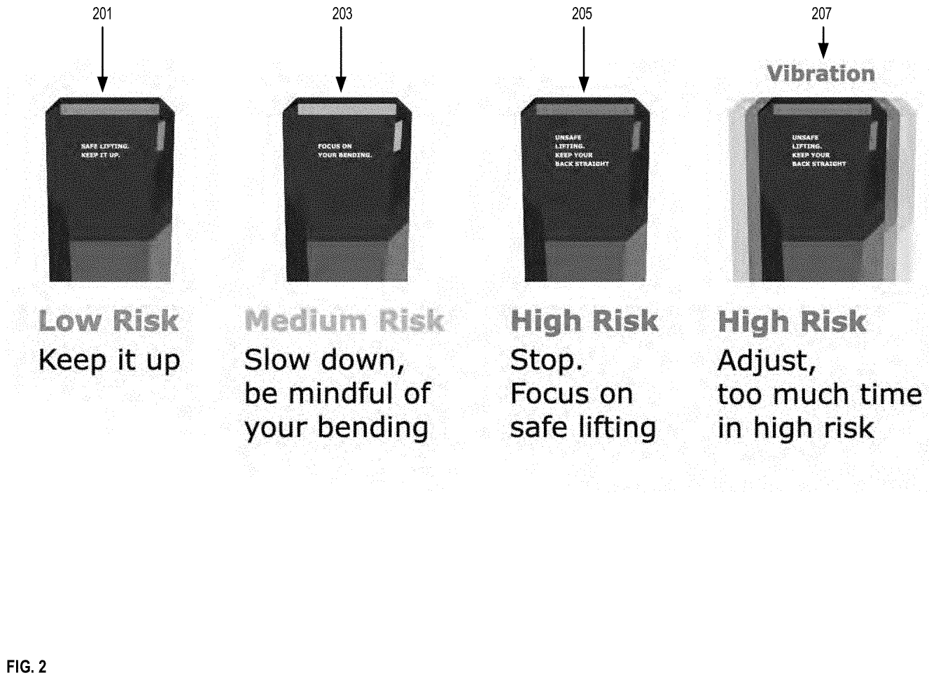

FIG. 2 illustrates an example of alerts emitted by the sensing system 100, in accordance with one or more embodiments of the present disclosure. In some instances, depending on the user activity, the sensing system 100 can emit an alert indicating that the activity being performed by the user is of low risk. In such a case, the sensing system 100 can display a message such as “Safe lifting. Keep it up.” Additionally, or alternatively the sensing system 100 can display a green color on a LED bar as shown at 201.

In some instances, depending on the user activity, the sensing system 100 can emit an alert indicating that the activity being performed by the user is of medium risk. In such a case, the sensing system 100 can display a message such as “Medium Risk. Slow down, be mindful of your bending.” Additionally, or alternatively the sensing system 100 can display a yellow color on a LED bar as shown at 203.

In some instances, depending on the user activity, the sensing system 100 can emit an alert indicating that the activity being performed by the user is of high risk. In such a case, the sensing system 100 can display a message such as “High Risk. Stop. Focus on safe lifting.” Additionally, or alternatively the sensing system 100 can display a red color on a LED bar as shown at 205.

In some instances, depending on the user activity, the sensing system 100 can emit an alert indicating that the activity being performed by the user is of high risk. In such a case, the sensing system 100 can display a message such as “High Risk. Adjust, too much time in high risk.” Additionally, or alternatively the sensing system 100 can display a red color on a LED bar and emit a vibrating signal as shown at 207.

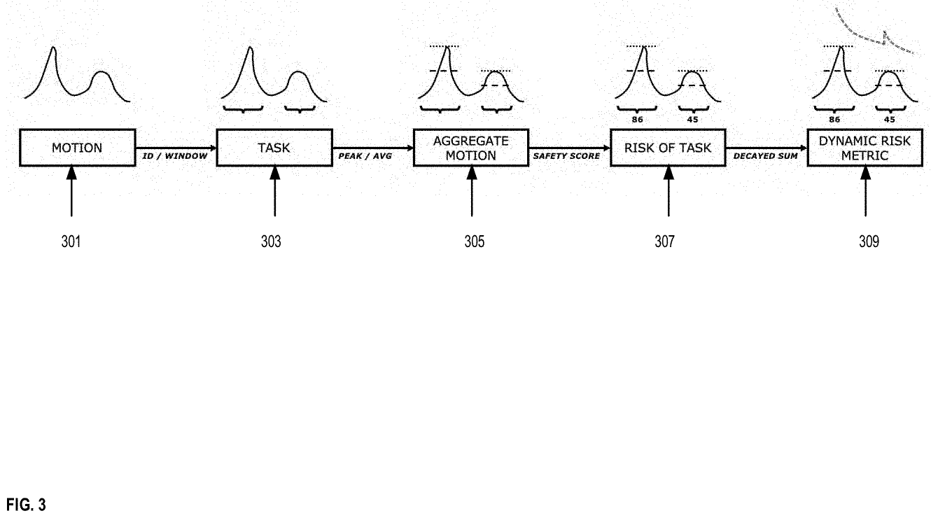

FIG. 3 is a flowchart illustrating an example of computations executed by the sensing system 100, in accordance with one or more embodiments of the present disclosure. In some implementations, the sensing system 100 can detect in real-time or near real-time motions or postures performed by a user as shown at 301.

The user motions and postures can be detected by the sensor system 100 via the sensors 103 discussed above with reference to FIG. 1. The data from the detected motions and postures can be stored in a window data structure to identify tasks performed by the user as shown at 303. In some embodiments, the window data structure may be constructed after identifying the tasks performed by the user. In some embodiments, the window data structure may include a subset of data from the sensors 103, the subset including a time-series of the data spanning a time period defined by a particular task. In some embodiments, the tasks may be identifying using any suitable task recognition model, such as, e.g., a machine learning model (e.g., convolutional neural network, recurrent neural network, support vector machine, decision trees, random forest, clustering model, etc. or any combination thereof).

In some instances, data from identified motions and postures are aggregated within a window data structure as shown at 305. Such an aggregation can be based on the average of the data associated with the task performed and/or based on peak values detected on the values corresponding to the task-performed.

In some instances, as shown at 307, the values of the aggregated motions can be used to compute a risk level associated with a task based on, for example, action count, a safety score, National Institute for Occupational Safety and Health (NIOSH) lifting equation, a Washington Industrial Safety and Health Act (WISHA) lifting equation, WISHH lifting equation, selected factors specific to a task, personalized factors associated with a user, or other suitable scores, equations or factors, or any combination thereof.

In some instances, as shown at 309, the risk values can be used to determine a dynamic risk metric that prioritizes risk according to time and risk patterns. For example, in some embodiments, the risk levels associated with each identified task can be combined utilizing a decayed sum process to produce a DRM. In some implementations, the DRM can be the cumulative sum of risk with polynomial or exponential decay applied for each risk level associated with each of the identified tasks by the time passed since each task was completed. Accordingly, the risk of the most recent tasks in time are prioritized while estimating the accumulated time-localized risk of an injury from the severity of a task, repeated exposure to risk levels from identified tasks, and rest time between intensive tasks. Thus, the DRM is an estimation of the instantaneous risk of injury that a user is exposed to, which is based on the riskiness levels associated with the way recent tasks were conducted by the user. The DRM can be used to indicate to users their current risk levels. Such risk levels can be compared to one or more threshold values to determine when an alert should be triggered by the sensing system 100.

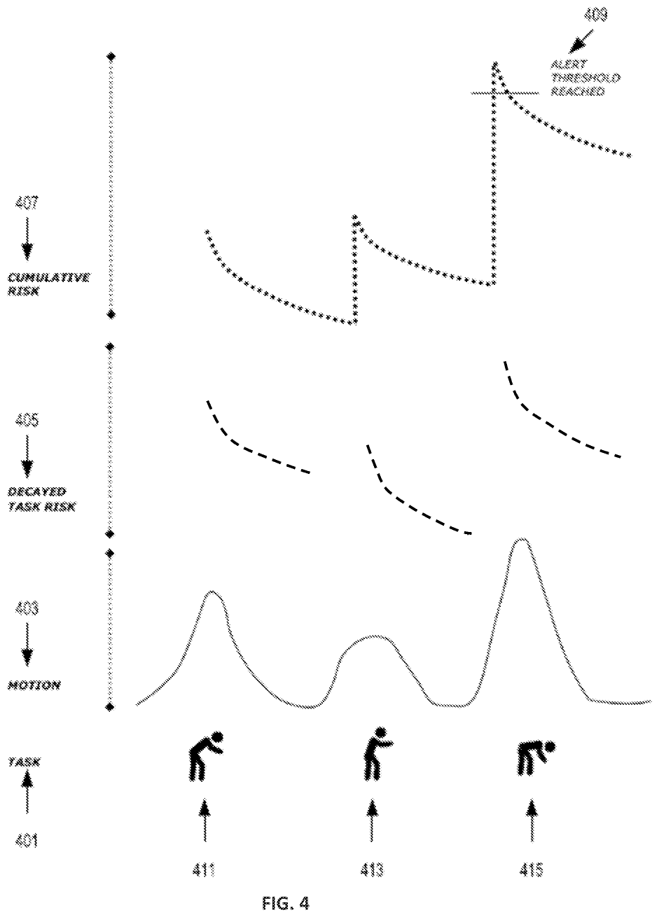

FIG. 4 is an example of the dynamic risk metric associated with a user task, in accordance with one or more embodiments of the present disclosure. In some instances, a user can perform a task 401. The task 401 includes bending at a certain level as shown at 411 (for example bending to pick up an object), straighten up as shown at 413, and bending at a lower level as shown at 415. The sensing system 100 captures motion data in real-time or near real-time as shown at 403 via sensors 103 discussed with reference to FIG. 1. Thereafter, the sensing system 100 computes the decayed task risk associated with each of the motions 411, 413, and 415 as shown at 405. The sensing system 100 utilizes the decayed task risk values 405 to compute a cumulative risk 407 associated with the task 101. In some instances, when the cumulative risk reaches an alert threshold 409, the sensing system can emit an alarm to indicate to the user a risk level and a corresponding recommendation as discussed with reference to FIG. 2.

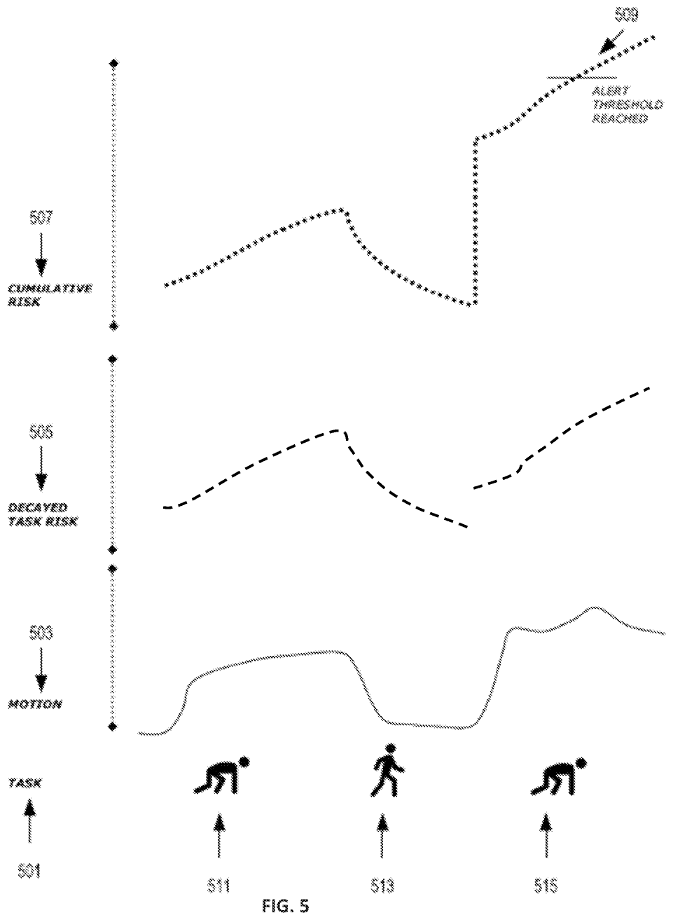

FIG. 5 is an example of the dynamic risk metric associated with a user task, in accordance with one or more embodiments of the present disclosure. In some instances, a user can perform a task 501. The task 501 includes bending at a certain low level as shown at 511 (for example bending to pick up an object from the floor), straighten up at a high level as shown at 513, and bending at the low level as shown at 515. The sensing system 100 captures motion data in real-time or near real-time as shown at 503 via sensors 103 discussed with reference to FIG. 1. Thereafter, the sensing system 100 computes the decayed task risk associated with each of the motions 511, 513, and 515 as shown at 505. The sensing system 100 utilizes the decayed task risk values 505 to compute a cumulative risk 507 associated with the task 501. In some instances, when the cumulative risk reaches an alert threshold 509, the sensing system can emit an alarm to indicate to the user a risk level and a corresponding recommendation as discussed with reference to FIG. 2.

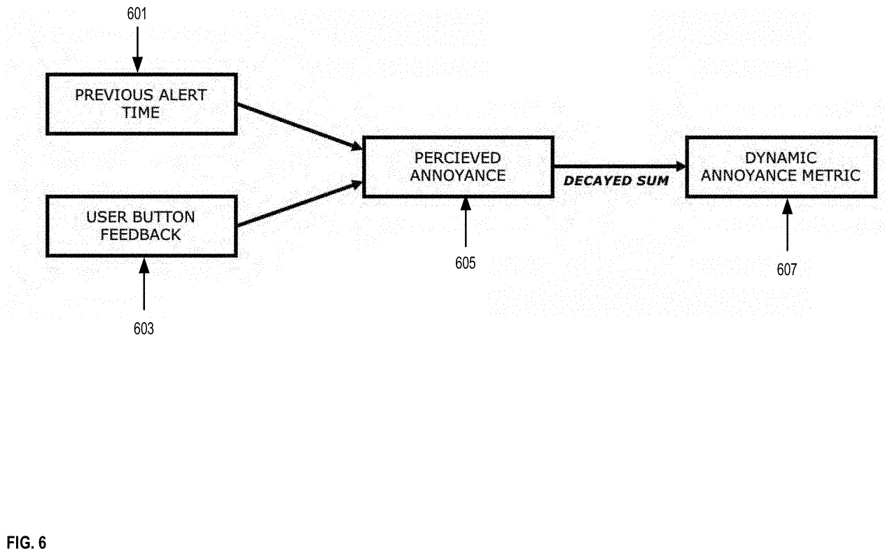

FIG. 6 is a flowchart illustrating an example of computations executed by sensing system 100, in accordance with one or more embodiments of the present disclosure. As discussed above the DAM is a measure of the density of safety alerts. The DAM can be utilized to model potential nuisances perceived by the user from repeated alerts. The DAM can also be utilized to allow or prevent the triggering of an alert. The DAM can be based on the number of safety alerts triggered from the system 100 and the number of pauses requested by the user. A user can request a pause to an alert via the sensing system button discussed with reference to FIG. 1.

In some embodiments, the sensing system 100 tracks the time when alerts are triggered as shown at 601. Likewise, the sensing system 100 tracks when a user presses the button to pause an alert as shown at 603 or provide user feedback to the sensing system 100. In some instances, each alert emitted by the sensing system 100 produces an annoyance value which is decayed based on the time since the alert was emitted and summed with other decayed alert annoyance values to produce the Dynamic Annoyance Metric 607. Further actions from the user such as pressing the user button feedback 603 following an alert can add to the DAM to boost the perceived annoyance of the user.

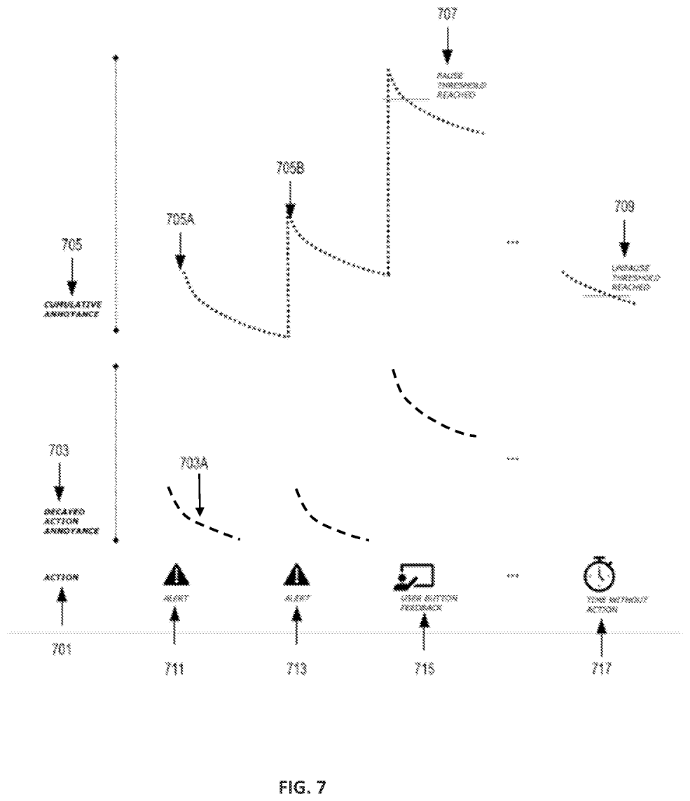

FIG. 7 is an example of the dynamic annoyance metric associated with a user task, in accordance with one or more embodiments of the present disclosure. In some instances, a user can perform an action or task 701. As discussed above, alerts 711 and 713 can be emitted by the sensing system 100 at a certain cadence. Each time an alert is emitted a decayed action annoyance is computed as shown at 703. The decay action annoyance tends to decrease over time as shown at 703A. However, the cumulative annoyance 705 can increase after a sequence of alerts, for example, from 705A to 705B.

In some instances, the cumulative annoyance 705 can reach a pause threshold as shown at 707, for example, when the user presses the feedback button. Pressing the feedback button may indicate that the user is annoyed by the sequence of alerts emitted by the system 100. Accordingly, the sensing system 100 can stop emitting alerts for a period of time until the cumulative annoyance or DAM decreases below a non-paused threshold as shown at 709. Thereafter, the sensing system 100 can continue emitting alerts based on the DRM metric.

In some embodiments, an alert can override a paused DAM if there is significant risk, for example, when the DRM has reached an extremely high value. For example, a DAM pause override threshold can be configured on the value of the DRM/DAM upon which an alert is trigger even when the DAM was in paused mode.

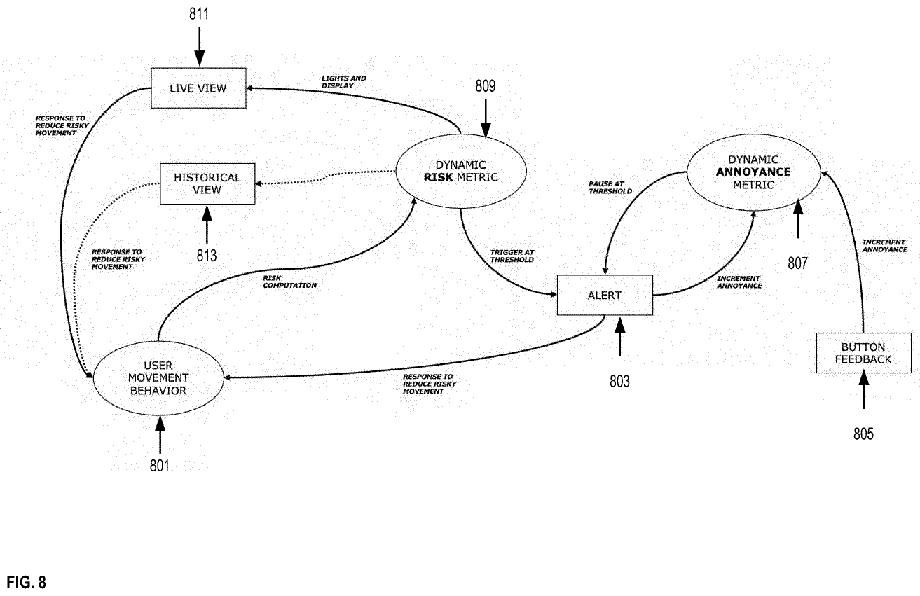

FIG. 8 is an example of adaptive variables that can be configured in the sensing system 100, in accordance with one or more embodiments of the present disclosure. In some embodiments, there can be multiple factors in the DAM-DRM-Alert-Pause pathway that can be configured with thresholds toward specific sensor actions. The DRM-Alert Threshold can be modulated to ensure that there is a usable spectrum of risk for a user to make improvements upon, as well as continually “raising the level” by having the DRM threshold become more stringent as a user improves their task-behavior toward less risky movements. The DAM-Pause Threshold can also be subject to change as an individual's optimal annoyance value prior to an alert is identified and tracked over time for a maximized behavioral change.

In some embodiments, a user movement behavior can be determined by the sensing system 100 as shown at 801. Thereafter, risk computations can be performed to determine the DRM as shown at 809. In some instances, the value of the DRM can reach a threshold causing the sensing system 100 to emit an alert as shown at 803. Such an alert can increment an annoyance measure and update the value of the DAM as shown at 807. As discussed above, in some instances, after an alert is emitted by the sensing system 100, a user can press the feedback button 805 which further increments the annoyance and the DAM level.

In some instances, when the DRM is updated the sensing system 100 can display in real-time a message and a predetermined color in the led color bar of the sensing system 100 as discussed with reference to FIG. 2 depending on the DRM level. The message and predetermined color in the led color bar can be shown at the live view 811. In some instances, a user can respond or react to the live view 811 by reducing risky movements, and then again, a user movement behavior is calculated at 801. In some instances, the DRM 809 does not change the message and the predetermined color in the led color bar, for example, when the DRM does not reach a subsequent threshold value. In such a case, the historical view 813 remains displayed in the sensing system 100. Thereafter, the user can reduce risky movements, and then again, a user movement behavior is calculated at 801.

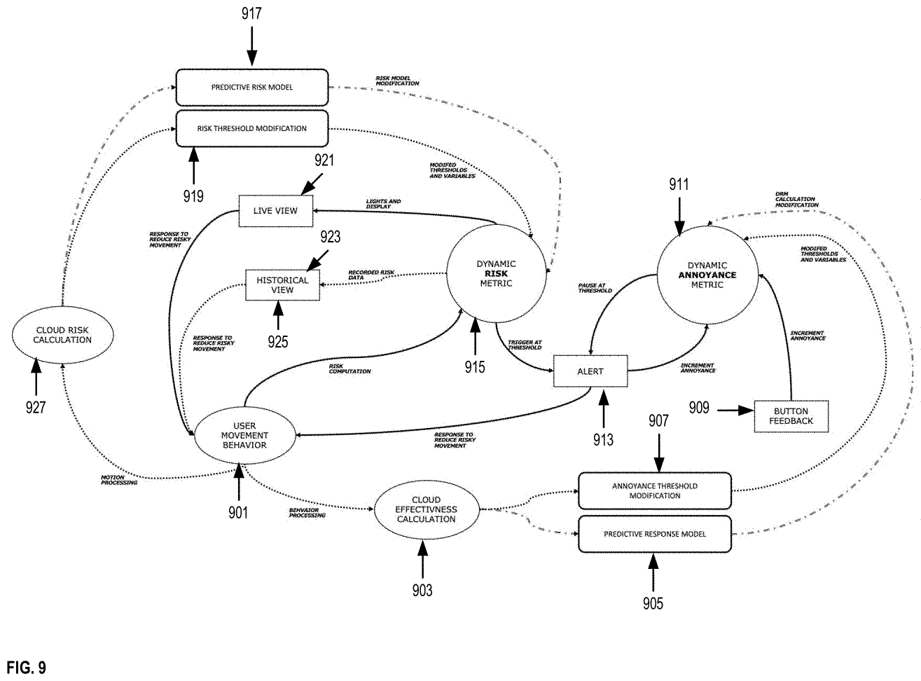

FIG. 9 is an example of an adaptive risk and annoyance model, in accordance with one or more embodiments of the present disclosure. In some embodiments, the annoyance threshold 907 and the risk threshold 919 can be modulated based on several parameters and an individualized learning model. In some instances, DAM and DRM can be used as preliminary engineered metrics to identify regions of DRM where injury can be predicted for a job function and to identify regions of DAM where maximal positive behavioral change in task movement can occur.

In some embodiments, a maximal behavioral change can be identified and modeled when there are is a significant change in motion metrics immediately following an alert, thereby isolating instances where the user has responded positively to an alert by, for example, adopting a better posture.

In some implementations, the risk model used to generate the DRM can be changed automatically to best address the type of injuries which are prevalent in tasks typically performed for a job function. Such changes to the risk model can be performed by analyzing historical injury data from the tasks and understanding the causes of those injuries. In some implementations, risks can be compared by running several risk models based on tracked motions to infer the type of task which registers the highest risk.

In some embodiments, there can be multiple factors in the DAM-DRM-Alert-Pause pathway that can be configured with thresholds toward specific sensor actions. The DRM-Alert Threshold can be modulated to ensure that there is a usable spectrum of risk for a user to make improvements upon, as well as continually “raising the level” by having the DRM threshold become more stringent as a user improves their task-behavior toward less risky movements. The DAM-Pause Threshold is also subject to change as an individual's optimal annoyance value prior to an alert can be identified and tracked over time for a maximized behavioral change.

In some embodiments, a user movement behavior can be determined by the sensing system 100 as shown at 901. Thereafter, risk computations can be performed to determine the DRM as shown at 915. In some instances, the value of the DRM can reach a threshold causing the sensing system 100 to emit an alert as shown at 913. Such an alert can increment an annoyance measure and update the value of the DAM as shown at 911. As discussed above, in some instances, after an alert is emitted by the sensing system 100, a user can press the feedback button 909 which further increments the annoyance and the DAM level.

In some instances, when the DRM is updated the sensing system 100 can display in real-time a message and a predetermined color in the led color bar of the sensing system 100 as discussed with reference to FIG. 2 depending on the DRM level. The message and predetermined color in the led color bar can be shown at the live view 921. In some instances, a user can respond or react to the live view 921 by reducing risky movements, and then again, a user movement behavior can be calculated at 901. In some instances, the DRM 915 does not change the message and the predetermined color in the led color bar, for example, when the DRM does not reach a subsequent threshold value. In such a case the historical view 923 remains displayed in the sensing system 100. Thereafter, the user can reduce risky movements, and then again, a user movement behavior can be calculated at 901.

In some embodiments, the model can perform a risk calculation 927 based on the user movement behavior 901 or motion processing. In some instances, based on the risk calculation 927, the predictive risk model 917 can be modified and used to compute the DRM 915. Likewise, in some instances, based on the risk calculation 927, the risk threshold 919 can be modified and used to compute the DRM 915.

In some embodiments, the model shown in FIG. 9 can perform an effectiveness calculation as shown at 903. In some instances, based on the effectiveness calculation 903, the annoyance threshold can be modified as shown at 907 and can be used to compute the DAM 911. Likewise, in some instances, based on the effectiveness calculation 903 the predictive response model 905 can be modified and can be used to compute the DAM 911.

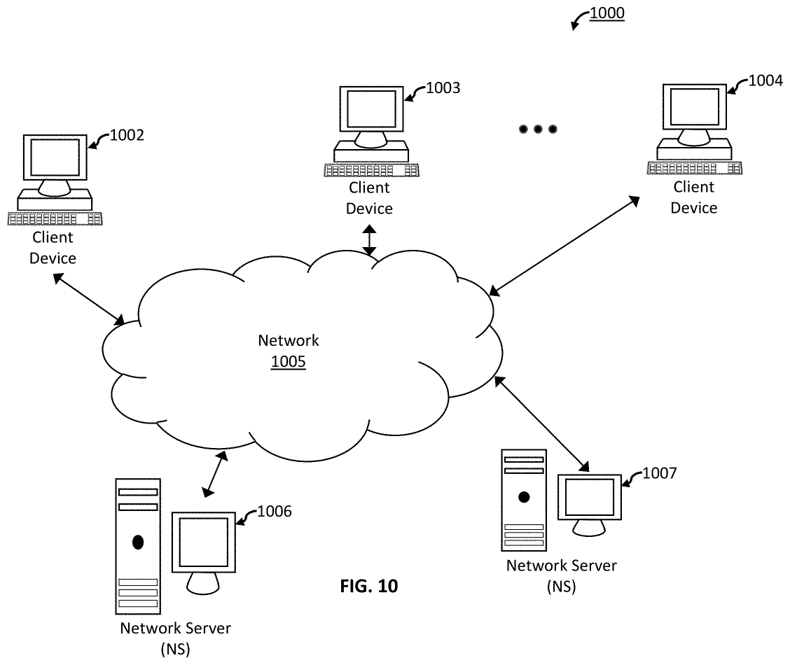

FIG. 10 depicts a block diagram of an exemplary computer-based system and platform for the sensing system 100 in accordance with one or more embodiments of the present disclosure.

FIG. 10 depicts a block diagram of an exemplary computer-based system and platform 1000 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 1000 may be configured to manage a large number of members and concurrent transactions, as detailed herein. In some embodiments, the exemplary computer-based system and platform 1000 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 10, member computing device 1002, member computing device 1003 through member computing device 1004 (e.g., clients) of the exemplary computer-based system and platform 1000 may include virtually any computing device capable of receiving and sending a message over a network (e.g., cloud network), such as network 1005, to and from another computing device, such as servers 1006 and 1007, each other, and the like. In some embodiments, the member devices 1002-1004 may be personal computers, multiprocessor systems, microprocessor-based or programmable consumer electronics, network PCs, and the like. In some embodiments, one or more member devices within member devices 1002-1004 may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, one or more member devices within member devices 1002-1004 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more member devices within member devices 1002-1004 may include may run one or more applications, such as Internet browsers, mobile applications, voice calls, video games, videoconferencing, and email, among others. In some embodiments, one or more member devices within member devices 1002-1004 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 1002-1004 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email. In some embodiments, a member device may contain a data recorder which is remotely downloadable by the user using network protocols such as FTP, SSH, or other file transfer mechanisms. In some embodiments, a member device may provide several levels of user interface, for example, advance user, standard user. In some embodiments, one or more member devices within member devices 1002-1004 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 1005 may provide network access, data transport and/or other services to any computing device coupled to it. In some embodiments, the exemplary network 1005 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 1005 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 1005 may include and implement, as an alternative or in conjunction with one or more of the above, a WiMAX architecture defined by the WiMAX forum. In some embodiments and, optionally, in combination of any embodiment described above or below, the exemplary network 1005 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 1005 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 1005 may also include mass storage, such as network attached storage (NAS), a storage area network (SAN), a content delivery network (CDN) or other forms of computer or machine readable media.

In some embodiments, the exemplary server 1006 or the exemplary server 1007 may be a web server (or a series of servers) running a network operating system, examples of which may include but are not limited to Apache on Linux or Microsoft IIS (Internet Information Services). In some embodiments, the exemplary server 1006 or the exemplary server 1007 may be used for and/or provide cloud and/or network computing. Although not shown in FIG. 10, in some embodiments, the exemplary server 1006 or the exemplary server 1007 may have connections to external systems like email, SMS messaging, text messaging, ad content providers, etc. Any of the features of the exemplary server 1006 may be also implemented in the exemplary server 1007 and vice versa.

In some embodiments, one or more of the exemplary servers 1006 and 1007 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the member computing devices 1001-1004.

In some embodiments and, optionally, in combination of any embodiment described above or below, for example, one or more exemplary computing member devices 1002-1004, the exemplary server 1006, and/or the exemplary server 1007 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

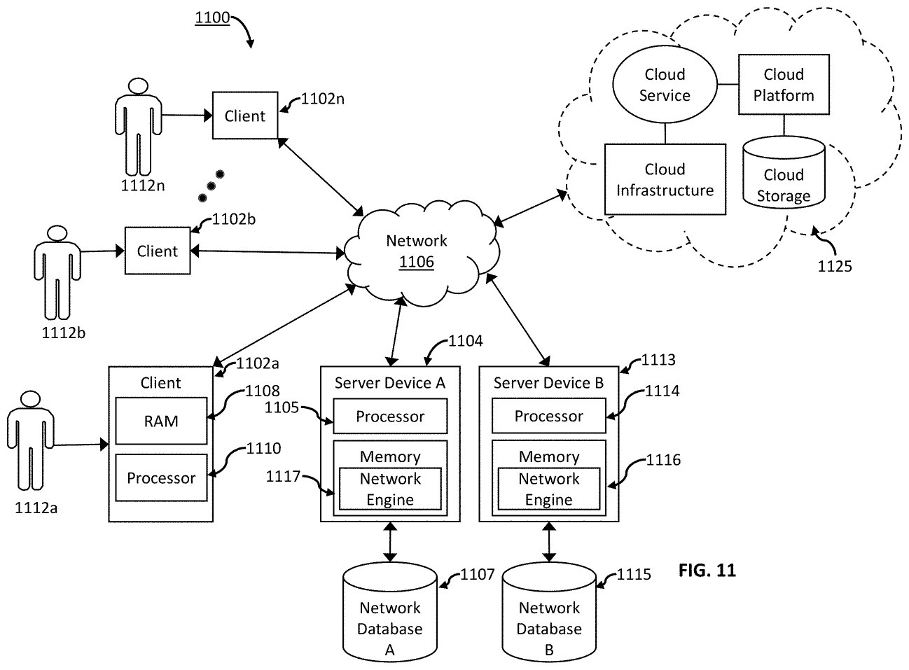

FIG. 11 depicts a block diagram of another exemplary computer-based system and platform for the sensing system 100 in accordance with one or more embodiments of the present disclosure.

FIG. 11 depicts a block diagram of another exemplary computer-based system and platform 1100 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 1102a, 1102b thru 1102n shown each at least includes a computer-readable medium, such as a random-access memory (RAM) 1108 coupled to a processor 1110 or FLASH memory. In some embodiments, the processor 1110 may execute computer-executable program instructions stored in memory 1108. In some embodiments, the processor 1110 may include a microprocessor, an ASIC, and/or a state machine. In some embodiments, the processor 1110 may include, or may be in communication with, media, for example computer-readable media, which stores instructions that, when executed by the processor 1110, may cause the processor 1110 to perform one or more steps described herein. In some embodiments, examples of computer-readable media may include, but are not limited to, an electronic, optical, magnetic, or other storage or transmission device capable of providing a processor, such as the processor 1110 of client 1102a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 1102a through 1102n may also comprise a number of external or internal devices such as a mouse, a CD-ROM, DVD, a physical or virtual keyboard, a display, or other input or output devices. In some embodiments, examples of member computing devices 1102a through 1102n (e.g., clients) may be any type of processor-based platforms that are connected to a network 1106 such as, without limitation, personal computers, digital assistants, personal digital assistants, smart phones, pagers, digital tablets, laptop computers, Internet appliances, and other processor-based devices. In some embodiments, member computing devices 1102a through 1102n may be specifically programmed with one or more application programs in accordance with one or more principles/methodologies detailed herein. In some embodiments, member computing devices 1102a through 1102n may operate on any operating system capable of supporting a browser or browser-enabled application, such as Microsoft™, Windows™, and/or Linux. In some embodiments, member computing devices 1102a through 1102n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 1102a through 1102n, users, 1112a through 1102n, may communicate over the exemplary network 1106 with each other and/or with other systems and/or devices coupled to the network 1106. As shown in FIG. 11, exemplary server devices 1104 and 1113 may include processor 1105 and processor 1114, respectively, as well as memory 1117 and memory 1116, respectively. In some embodiments, the server devices 1104 and 1113 may be also coupled to the network 1106. In some embodiments, one or more member computing devices 1102a through 1102n may be mobile clients.

In some embodiments, at least one database of exemplary databases 1107 and 1115 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

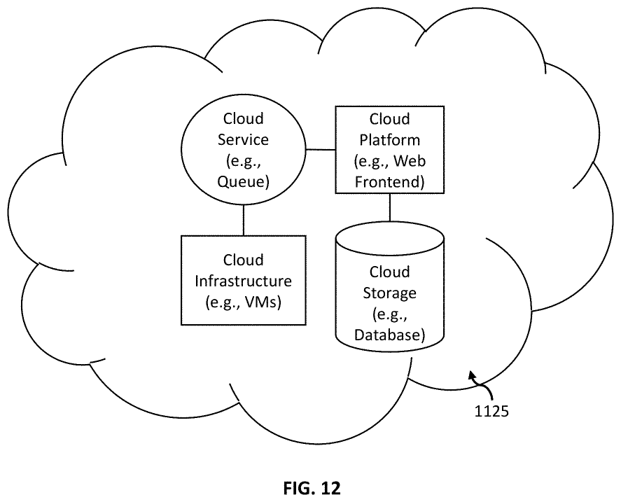

FIG. 12 depicts illustrative schematics of an exemplary implementation of the cloud computing/architecture(s) in which embodiments of the sensing system 100 may be specifically configured to operate in accordance with some embodiments of the present disclosure.

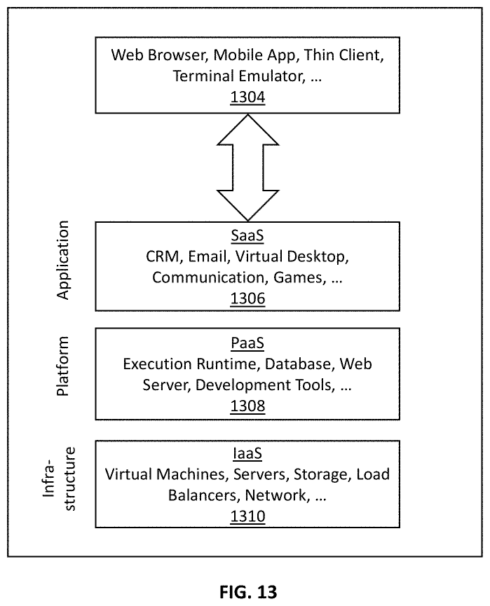

FIG. 13 depicts illustrative schematics of another exemplary implementation of the cloud computing/architecture(s) in which embodiments of the sensing system 100 may be specifically configured to operate in accordance with some embodiments of the present disclosure.

In some embodiments, the exemplary inventive computer-based systems/platforms, the exemplary inventive computer-based devices, and/or the exemplary inventive computer-based components of the present disclosure may be specifically configured to operate in a cloud computing/architecture 1125 such as, but not limiting to: infrastructure a service (IaaS) 1310, platform as a service (PaaS) 1308, and/or software as a service (SaaS) 1306 using a web browser, mobile app, thin client, terminal emulator or other endpoint 1304. FIGS. 12 and 13 illustrate schematics of exemplary implementations of the cloud computing/architecture(s) in which the exemplary systems of the present disclosure may be specifically configured to operate. Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments, programmed computing systems with associated devices can be configured to operate in the distributed network environment, communicating with one another over one or more suitable data communication networks (e.g., the Internet) and utilizing one or more suitable data communication protocols.

In some embodiments, the material disclosed herein may be implemented in hardware and software or firmware or a combination of them or as instructions stored on a non-transitory machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices, and others. In some embodiments, the non-transitory machine-readable medium can include one or more storage devices, and memory devices described above.

Examples of hardware elements may include processors, microprocessors, circuits, circuit elements (e.g., transistors, resistors, capacitors, inductors, and so forth), integrated circuits, Application Specific Integrated Circuits (ASIC), Programmable Logic Devices (PLD), Digital Signal Processors (DSP), Field Programmable Gate Array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or Central Processing Unit (CPU). In various implementations, the one or more processors may be dual-core processor(s), dual-core mobile processor(s), and so forth.

Computer systems, and systems, as used herein, can include any combination of hardware and software. Examples of software may include software components, programs, applications, operating system software, firmware, software modules, routines, subroutines, functions, methods, procedures, software interfaces, Application Programming Interfaces (API), computer code, data, data variables, or any combination thereof that can be processed by a computing device as computer-executable instructions.

In some embodiments, one or more of computer-based systems of the present disclosure may include or be incorporated, partially or entirely into at least one Personal Computer (PC), laptop computer, tablet, portable computer, smart device (e.g., smart phone, smart tablet or smart television), Mobile Internet Device (MID), messaging device, data communication device, server computer, and so forth.

In some embodiments, computer-based systems of the present disclosure may be configured to utilize hardwired circuitry and/or hardware components that may be used in place of or in combination with software instructions to implement system 100 consistent with principles of the disclosure. Thus, implementations consistent with principles of the disclosure are not limited to any specific combination of hardware circuitry or hardware components and/or software

In some embodiments, software specifically programmed in accordance with one or more principles of the present disclosure may also be available as a client-server software application, or as a web-enabled software application. For example, software specifically programmed in accordance with one or more principles of the present disclosure may also be embodied as a software package installed on a hardware device.

In some embodiments, computer-based systems of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000. As used herein, the term “user” shall have a meaning of at least one user.

The aforementioned examples are, of course, illustrative and not restrictive.

At least some aspects of the present disclosure will now be described with reference to the following numbered clauses.
1. An apparatus, comprising:
   a processor;
   a set of sensors; and
   a non-transitory memory storing instructions which, when executed by the processor, causes the processor to:
      capture raw sensor data via the set of sensors while a user performs a series of activities wearing the set of sensors for a predetermined time;
      determine a dynamic risk metric based on the raw sensor data, wherein the dynamic risk metric is indicative of an injury risk associated with the user; and
      generate, based on a dynamic annoyance metric, indicative of an alert cadence, an alert upon a determination that the dynamic risk metric has reached a predetermined threshold, wherein the dynamic annoyance metric is customized based on at least one user behavior.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the methodologies, the systems, and the devices described herein can be utilized in any combination with each other. Further still, the various steps may be carried out in any desired order (and any desired steps may be added and/or any desired steps may be eliminated).

What is claimed is:

1. A system, comprising:
a processor;
a set of sensors associated with a user;
wherein the set of sensors produce raw sensor data comprising at least one motion-related measurement of motion of the user; and
a non-transitory memory storing instructions which, when executed by the processor, causes the processor to:
receive the raw sensor data via the set of sensors;
determine at least one aggregate motion value associated with at least one motion based at least in part on at least one statistical aggregation of at least one subset of the raw sensor data;
determine a risk metric based at least in part on the at least one aggregate motion value to represent a risk of injury associated with the at least one subset of the raw sensor data;
access a risk history comprising a plurality of historical risk scores associated with the user;
determine a dynamic risk metric based at least in part on the risk history and the risk metric, wherein the dynamic risk metric is indicative of an injury risk associated with the user;
determine a dynamic annoyance metric based at least in part on at least one previous alert associated with the user;
wherein the dynamic annoyance metric is indicative of an alert cadence;
wherein the dynamic annoyance metric is customized based on at least one user behavior; and
generate, based on the dynamic annoyance metric, an alert upon a determination that the dynamic risk metric has reached a predetermined threshold.

2. The system as recited in claim 1, wherein the non-transitory memory storing instructions which, when executed by the processor, further causes the processor to:
utilize at least one task recognition model to identify at least one task associated with the motion of the user based at least in part on the raw sensor data;
determine at least one window of time spanning a period of time defined by the at least one task;
generate at least one window data structure comprising the subset of the raw sensor;
wherein the subset of raw sensor data is associated with the at least one window of time; and
determine at least one aggregate motion value associated with at least one motion represented within the at least one window data structure based at least in part on at least one statistical aggregation of the subset of the raw sensor data.

3. The system as recited in claim 1, wherein the non-transitory memory storing instructions which, when executed by the processor, further causes the processor to:
determine a decayed sum associated with the risk metric based at least in part on the risk history.

4. The system as recited in claim 1, wherein the risk metric comprises at least one of:
an action count representing a number of actions performed,
a Safety Score,
a National Institute for Occupational Safety and Health (NIOSH) Lifting Equation,
a Washington Industrial Safety and Health Act (WISHA) lifting equation,
a WISHH Lifting Equation,
selected factors specific to task, or
personalized factors associated with an educational program.

5. The system as recited in claim 1, wherein the non-transitory memory storing instructions which, when executed by the processor, further causes the processor to:
access an alert log storing at least one record of the at least one previous alert;
wherein the at least one record comprises:
at least one user feedback in response to the at least one previous alert and
at least one alert time associated with the at least one previous alert;
determine a perceived annoyance associated with the alert based at least in part on the at least one previous alert and the at least one user feedback; and
determine the dynamic annoyance metric based at least in part on the perceived annoyance.

6. The system as recited in claim 5, wherein the non-transitory memory storing instructions which, when executed by the processor, further causes the processor to:
determine a decayed sum associated with the perceived annoyance based at least in part on the at least one record of the at least one previous alert; and
generating the dynamic annoyance metric based at least in part on the decayed sum associated with the perceived annoyance.

7. The system as recited in claim 5, wherein the non-transitory memory storing instructions which, when executed by the processor, further causes the processor to:
receive at least one user feedback in response to the alert; and
store a record of the alert and the at least one user feedback in the alert log.

8. A method, comprising:
receiving, by at least one processor, raw sensor data via a set of sensors;
wherein the raw sensor data comprises at least one motion-related measurement of motion of the user;
determining, by the at least one processor, at least one aggregate motion value associated with at least one motion based at least in part on at least one statistical aggregation of at least one subset of the raw sensor data;
determining, by the at least one processor, a risk metric based at least in part on the at least one aggregate motion value to represent a risk of injury associated with the at least one subset of the raw sensor data;
accessing, by the at least one processor, a risk history comprising a plurality of historical risk scores associated with the user;
determining, by the at least one processor, a dynamic risk metric based at least in part on the risk history and the risk metric, wherein the dynamic risk metric is indicative of an injury risk associated with the user;
determining, by the at least one processor, a dynamic annoyance metric based at least in part on at least one previous alert associated with the user;
wherein the dynamic annoyance metric is indicative of an alert cadence;
wherein the dynamic annoyance metric is customized based on at least one user behavior; and
generating, by the at least one processor, based on the dynamic annoyance metric, an alert upon a determination that the dynamic risk metric has reached a predetermined threshold.

9. The method as recited in claim 8, further comprising:
utilize at least one task recognition model to identify at least one task associated with the motion of the user based at least in part on the raw sensor data;
determining, by the at least one processor, at least one window of time spanning a period of time defined by the at least one task;
generating, by the at least one processor, at least one window data structure comprising the subset of the raw sensor;
wherein the subset of raw sensor data is associated with the at least one window of time; and
determining, by the at least one processor, at least one aggregate motion value associated with at least one motion represented within the at least one window data structure based at least in part on at least one statistical aggregation of the subset of the raw sensor data.

10. The method as recited in claim 8, further comprising:
determining, by the at least one processor, a decayed sum associated with the risk metric based at least in part on the risk history.

11. The method as recited in claim 8, wherein the risk metric comprises at least one of:
an action count representing a number of actions performed,
a Safety Score,
a National Institute for Occupational Safety and Health (NIOSH) Lifting Equation,
a Washington Industrial Safety and Health Act (WISHA) lifting equation,
a WISHH Lifting Equation,
selected factors specific to task, or
personalized factors associated with an educational program.

12. The method as recited in claim 8, further comprising:
accessing, by the at least one processor, an alert log storing at least one record of the at least one previous alert;
wherein the at least one record comprises:
at least one user feedback in response to the at least one previous alert and
at least one alert time associated with the at least one previous alert;
determining, by the at least one processor, a perceived annoyance associated with the alert based at least in part on the at least one previous alert and the at least one user feedback; and
determining, by the at least one processor, the dynamic annoyance metric based at least in part on the perceived annoyance.

13. The method as recited in claim 5, further comprising:
determining, by the at least one processor, a decayed sum associated with the perceived annoyance based at least in part on the at least one record of the at least one previous alert; and
generating the dynamic annoyance metric based at least in part on the decayed sum associated with the perceived annoyance.

14. The method as recited in claim 5, further comprising:
receiving, by the at least one processor, at least one user feedback in response to the alert; and
store a record of the alert and the at least one user feedback in the alert log.
